(19) United States
(12) Patent Application Publication
(10) Pub. No.: US 2014/0149777 A1
(43) Pub. Date: May 29, 2014

(54) POWER SAVING SYSTEM AND METHOD

(71) Applicant: HON HAI PRECISION INDUSTRY CO., LTD., New Taipei (TW)

(72) Inventor: CHIH-HUANG WU, New Taipei (TW)

(21) Appl. No.: 13/929,814

(22) Filed: Jun. 28, 2013

(30) Foreign Application Priority Data
Nov. 29, 2012 (TW) 101144672

(51) Int. Cl. G06F 1/32

(52) U.S. Cl. CPC G06F 1/325
USPC 713/324

(57) ABSTRACT

A computer obtains signals from interfaces of a graphics card in the computer. The computer turns off a switch that provides power to a graphics output unit corresponding to the interface, in response to a determination that the interface is not connected to a display device. The computer turns on the switch that provides power to the graphics output unit corresponding to the interface, in response to the determination that the interface is connected to the display device.

### BACKGROUND

1. Technical Field

The embodiments of the present disclosure relate to cloud computing technology, and particularly to a power saving system and method via cloud computing.

2. Description of Related Art

A computer includes a graphics card, which includes many graphics output units (e.g., digital-to-analog converters). However, in most situations, not all graphics output units operate at the same time. When only a few graphics output units are operating, power to the other idle units is wasted. Therefore, there is room for improvement in the art.

### BRIEF DESCRIPTION OF THE DRAWINGS

FIG. 1 is a block diagram of one embodiment of a computer including a power saving system.

FIG. 2 is a block diagram of one embodiment of the power saving system included in the computer of FIG. 1.

FIG. 3 is a flowchart of one embodiment of a power saving method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

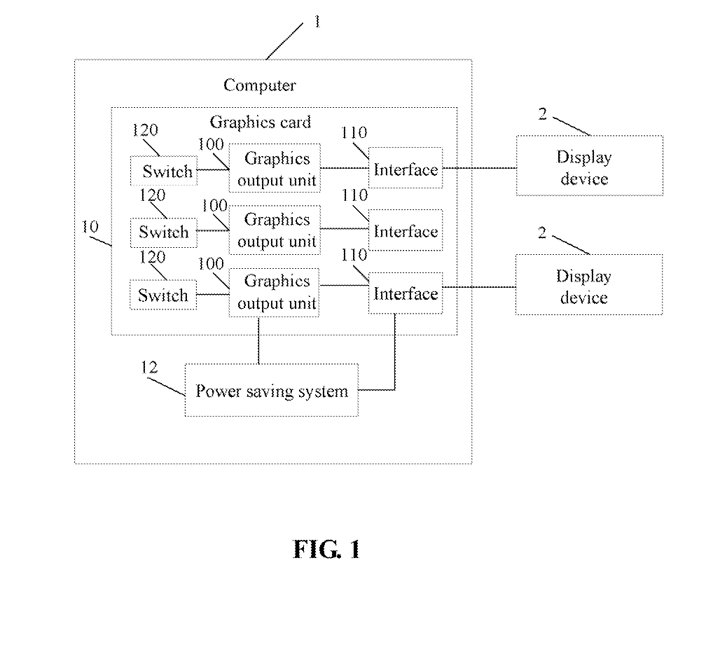

FIG. 1 is a block diagram of one embodiment of a computer 1. In this embodiment, the computer 1 includes a graphics card 10, and a power saving system 12. The computer 1 is connected to one or more display devices 2 (two are shown).

The graphics card 10 includes one or more graphics output units 100 (three are shown in FIG. 1) and one or more interfaces 110 (three are shown in FIG. 1). Each graphics output unit 100 is connected to one interface 110. The computer 1 is connected to the one or more display devices 2 via the interfaces 110. Each interface 110 may also be connected to other device (e.g., a printer). The graphics output unit 100 is used to output an image or a video to the display device 2 using the interfaces 110. The graphics output unit 100 may be, but is not limited to, a digital-to-analog converter (DAC) or a binary-to-analog converter (BAC). The interface 110 may be, but are not limited to, a video graphics array (VGA) interface, a digital video interface (DVI), a display port (DP), or a high-definition multimedia interface (HDMI). Additionally, each graphics output unit 100 is connected to a switch 120. The switch 120 is capable of providing power to the graphics output unit 100. The power saving system 12 turns the switch 120 on and off to save power.

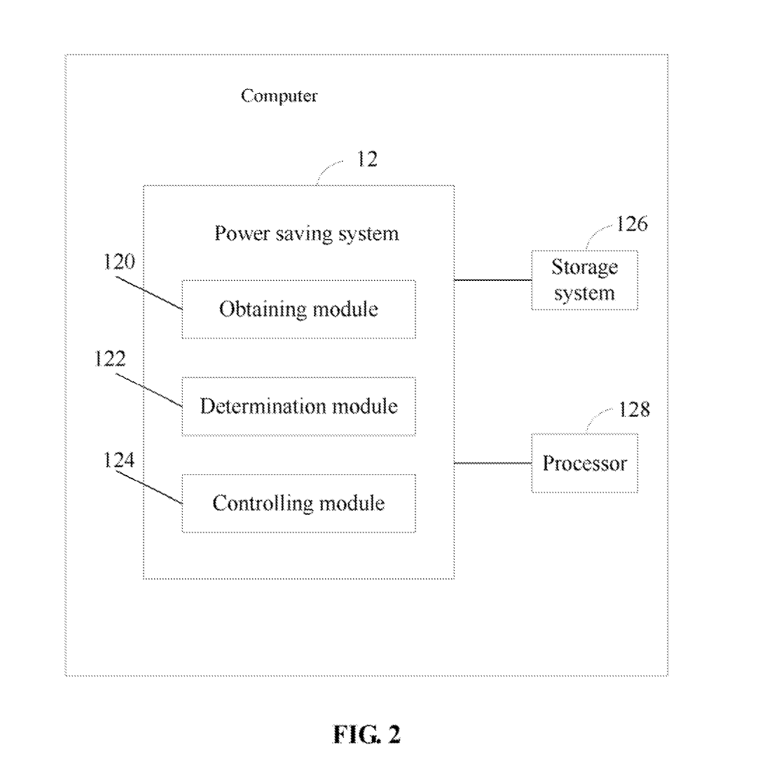

FIG. 2 is a block diagram of one embodiment of the power saving system 12 in the computer 1 of FIG. 1. The computer 1 further includes a storage system 126 and at least one processor 128. In one embodiment, the power saving system 12 includes an obtaining module 120, a determination module 122, and a controlling module 124. The modules 120-124 may include computerized code in the form of one or more programs that are stored in the storage system 126. The computerized code includes instructions that are executed by the at least one processor 128 to provide functions for the modules 120-124. The storage system 126 may be a memory, such as an EPROM memory chip, hard disk drive (HDD), or flash memory stick.

The obtaining module 120 obtains signals from each interface 110 of the graphics card 10. In one embodiment, each interface 110 includes a general purpose input output (GPIO) chip, the signals are stored in the GPIO chip. The GPIO chip originally stores low frequency signals if the interface 110 does not connect to any device. If the interface 110 is connected to a display device 2, the low frequency signals in the GPIO chip are changed to high frequency signals. If the interface 110 is connected to other device (e.g., a printer), the signals in the GPIO chip includes the low frequency signals. Additionally, if a frequency of the signals is greater than or equal to three mega Hertz (MHz), the signals are determined as high frequency signals. If the frequency of the signals is lower than or equal to one mega Hertz (MHz), the signals are determined as low frequency signals. The obtaining module 120 obtains the signals from the GPIO chip of the interface 110.

The determination module 122 determines if the interface 110 is connected to the display device 2 according to the obtained signals. In one embodiment, if the signals are high frequency signals, the determination module 122 determines that the interface 110 is connected to the display device 2. If the signals are low frequency signals, the determination module 122 determines that the interface 110 is not connected to the display device 2.

The controlling module 124 turns off a switch 120 that provides power to the graphics output unit 100 corresponding to the interface 110, in response to a determination that the interface 110 is not connected to the display device 2. The switch 120 is originally turned on when the graphics card 10 starts up, and the graphics output unit 100 connected to the switch 120 works. If the interface 110 is connected to the display device 2, the controlling module 124 turns off the switch 120, and the graphics output unit 100 corresponding to the interface 110 stops working to save power.

The obtaining module 120 periodically (e.g., every five minutes) obtains the signals from the interface 110 corresponding to the graphics output unit 100.

The determination module 122 determines if the interface 110 is connected to the display device 2 according to the obtained signals.

The controlling module 124 turns on the switch 120 that provides power to the graphics output unit 100 corresponding to the interface 110, in respond to the determination that the interface 110 is connected to the display device 2. In one embodiment, the graphics output unit 100 corresponding to the interface 110 restarts when the switch 120 is turned on.

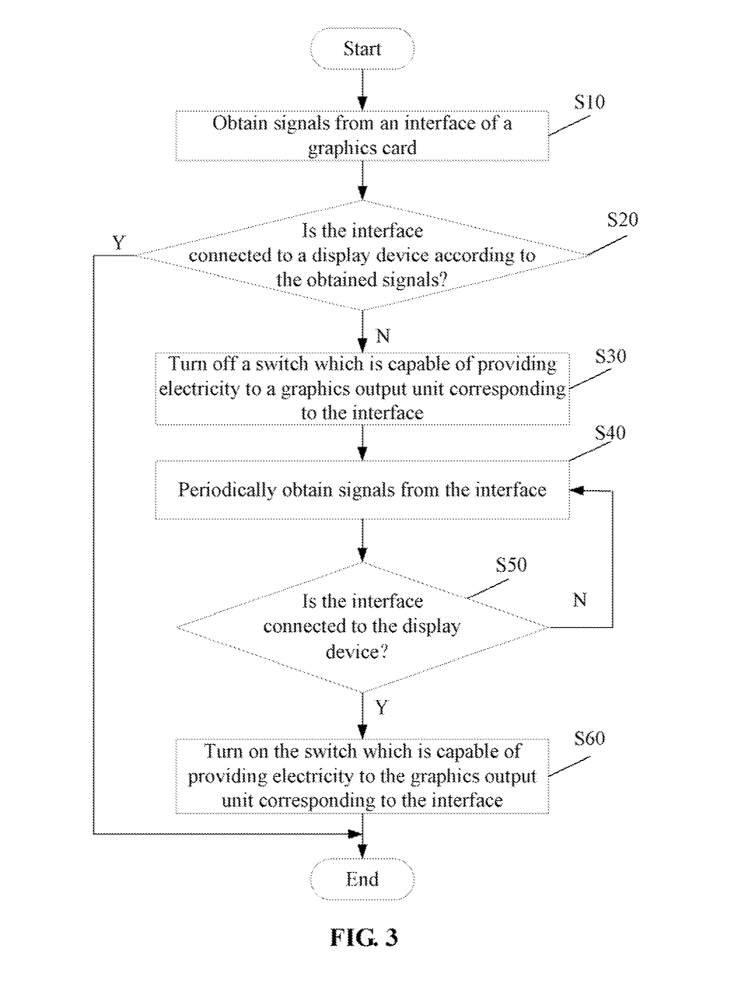

FIG. 3 is a flowchart of one embodiment of a power saving method. Depending on the embodiment, additional steps may be added, others deleted, and the ordering of the steps may be changed.

In step S10, the obtaining module 120 obtains signals from each interface 110 of the graphics card 10. As mentioned above, the obtaining module 120 obtains the signals from the GPIO chip of the interface 110.

In step S20, the determination module 122 determines if the interface 110 is connected to the display device 2 according to the obtained signals. In one embodiment, if frequency of the signals in the GPIO chip of the interface 110 is greater than or equal to three mega Hertz (MHz), the signals are determined as the high frequency signals, the procedure goes to step S30. If frequency of the signals in the GPIO chip of the interface 110 is lower than or equal to one mega Hertz (MHz), the signals are determined as the low frequency signals, the procedure ends.

In step S30, the controlling module 124 turns off a switch 120 that provides power to the graphics output unit 100 corresponding to the interface 110. For example, assuming that the switch A1 is connected to the graphics output unit A2, and the graphics output unit A2 is connected to the interface A3. The switch A1 is originally turned on when the graphics card 10 starts, and the graphics output unit A2 connected to the switch A1 works. If the interface A3 is not connected to the display device 2, the controlling module 124 turns off the switch A1, and the graphics output unit A2 stop working for power saving.

In step S40, the obtaining module 120 obtains periodically (e.g., every five minutes) the signals from the interface 110 corresponding to the graphics output unit 100.

In step S50, the determination module 122 determines if the interface 110 is connected to the display device 2 according to the obtained signals. If the frequency of the signals in the GPIO chip of the interface A3 is greater than or equal to three mega Hertz (MHz), the signals are determined as the high frequency signals, the procedure goes to step S30. If frequency of the signals in the GPIO chip of the interface A3 is lower than or equal to one mega Hertz (MHz), the signals are determined as the low frequency signals, the procedure returns to step S40.

In step S60, the controlling module 124 turns on the switch that provides power to the graphics output unit 100 corresponding to the interface 110. In one embodiment, the graphics output unit A2 restarts when the switch A1 is turned on.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, comprising:
a graphics card, which comprises one or more graphics output units and one or more interfaces, wherein each graphics output unit is connected to one interface;
at least one processor; and
a storage system storing one or more programs that are executed by the at least one processor to perform a power saving method, the method comprising:
obtaining signals from each interface of the graphics card;
determining if the interface is connected to a display device according to the obtained signals;
turning off a switch that provides power to the graphics output unit corresponding to the interface, in response to a determination that the interface is not connected to the display device;
turning on the switch that provides power to the graphics output unit corresponding to the interface, in respond to the determination that the interface is connected to the display device.

2. The computer of claim 1, wherein the interface comprises a general purpose input output chip, and the general purpose input output chip stores the signals.

3. The computer of claim 2, wherein the interface is connected to the display device upon the condition that the signals in the general purpose input output chip are high frequency signals.

4. The computer of claim 2, wherein the interface is connected to the display device upon the condition that the signals in the general purpose input output chip are low frequency signals.

5. The computer of claim 3, wherein the signals are determined as the high frequency signals upon the conditions that frequency of the signals is greater than or equal to three mega Hertz.

6. The computer of claim 4, wherein the signals are determined as the low frequency signals upon the conditions that the frequency of the signals is lower or equal to one mega Hertz.

7. A power saving method implemented by a computer comprising a graphics card, wherein the graphics card comprises one or more graphics output unit and one or more interfaces, and each graphics output unit is connected to one interface, the method comprising:
obtaining signals from each interface of the graphics card;
determining if the interface is connected to a display device according to the obtained signals;
turning off a switch that provides power to the graphics output unit corresponding to the interface, in response to a determination that the interface is not connected to the display device; and
turning on the switch that provides power to the graphics output unit corresponding to the interface, in respond to the determination that the interface is connected to the display device.

8. The method of claim 7, wherein the interface comprises a general purpose input output chip, and the general purpose input output chip stores the signals.

9. The method of claim 8, wherein the interface is connected to the display device upon the condition that the signals in the general purpose input output chip are high frequency signals.

10. The method of claim 8, wherein the interface is connected to the display device upon the condition that the signals in the general purpose input output chip are low frequency signals.

11. The method of claim 9, wherein the signals are determined as the high frequency signals upon the conditions that frequency of the signals is greater than or equal to three mega Hertz.

12. The method of claim 11, wherein the signals are determined as the low frequency signals upon the conditions that the frequency of the signals is lower or equal to one mega Hertz.

13. A non-transitory computer-readable medium having stored thereon instructions that, when executed by a computer, a computer comprising a graphics card, wherein the graphics card comprises one or more graphics output unit and one or more interfaces, and each graphics output unit is connected to one interface, causing the computer to perform a power saving method, the method comprising:
obtaining signals from each interface of the graphics card;
determining if the interface is connected to a display device according to the obtained signals;
turning off a switch that provides power to the graphics output unit corresponding to the interface, in response to a determination that the interface is not connected to the display device; and
turning on the switch that provides power to the graphics output unit corresponding to the interface, in respond to the determination that the interface is connected to the display device.

14. The non-transitory computer-readable medium of claim 13, wherein the interface comprises a general purpose input output chip, and the general purpose input output chip stores the signals.

15. The non-transitory computer-readable medium of claim 14, wherein the interface is connected to the display device upon the condition that the signals in the general purpose input output chip are high frequency signals.

16. The non-transitory computer-readable medium of claim 14, wherein the interface is connected to the display device upon the condition that the signals in the general purpose input output chip are low frequency signals.

17. The non-transitory computer-readable medium of claim 15, wherein the signals are determined as the high frequency signals upon the conditions that frequency of the signals is greater than or equal to three mega Hertz.

18. The non-transitory computer-readable medium of claim 17, wherein the signals are determined as the low frequency signals upon the conditions that the frequency of the signals is lower or equal to one mega Hertz.
